(19) United States
(12) Patent Application Publication
(10) Pub. No.: US 2019/0257215 A1
(43) Pub. Date: Aug. 22, 2019

(54) AXIAL PISTON MACHINE

(71) Applicant: Mahle International GmbH, Stuttgart (DE)

(72) Inventors: Michael Bucher, Berlin (DE); Christoph Fiala, Potsdam (DE); Mirko Guenther, Berlin (DE); Michael Hoetger, Berlin (DE)

(21) Appl. No.: 15/774,938

(22) PCT Filed: Nov. 9, 2016
(86) PCT No.: PCT/EP2016/077175

§ 371 Date: May 9, 2018

(30) Foreign Application Priority Data
Nov. 10, 2015 (DE) 10 2015 222 120.2

(51) Int. Cl. F01K 23/10; F03C 1/047; F01N 5/02

(52) U.S. Cl. CPC F01K 23/10; F01N 2290/04; F01N 5/02; F03C 1/0472

(57) ABSTRACT

An axial piston machine may include a rotor mounted rotatably in a housing. The axial piston machine may also include a plurality of cylinders in which a plurality of pistons are disposed such that the plurality of pistons are translationally movable. The plurality of cylinders may be arranged in a ring-like manner around the rotor. Further, the axial piston machine may include a starter device configured to exert a pulse-like torque on the rotor to initiate a starting operation. The starter device may be couplable to the rotor.

### CROSS-REFERENCE TO RELATED APPLICATIONS

This application claims priority to International Patent Application No. PCT/EP2016/077175, filed on Nov. 9, 2016, and German Patent Application No. 10 2015 222 120.2, filed on Nov. 10, 2015, the contents of both of which are hereby incorporated by reference in their entirety.

### TECHNICAL FIELD

The present invention relates to an axial piston machine with a rotor mounted rotatably in a housing. The invention also relates to a motor vehicle equipped with such an axial piston machine and a method for starting such an axial piston machine.

### BACKGROUND

Many species-related axial piston machines with a rotor mounted rotatably in a housing with cylinders arranged in a ring around the rotor, inside which cylinders the pistons are arranged to be translationally movable, are known from the prior art. Such axial piston machines are used as expansion machines in heat recovery systems in motor vehicles, for example. This is designed particularly to improve the efficiency of an internal combustion engine, since previously more than 30% of energy was dissipated unused into the atmosphere as waste heat, in particular via the exhaust gases.

A drive device for an internal combustion engine and an expansion machine which can be coupled to a drivetrain of the drive device, in which the expansion machine is arranged in a closed steam circuit in which the working medium is evaporated by the waste heat generated during operation of the internal combustion engine is known from WO 2011/012441 A1. The expansion machine is or can be coupled to an element of a transmission assembly installed downstream of the internal combustion engine which rotates during operation of the drive device. This is intended in particular to enable better integration of the expansion machine in the drive device.

Known heat recovery systems in motor vehicles need a certain amount of time after the internal combustion engine is started before a working medium in the heat recovery system is heated and vaporised enough to be able to start an axial piston machine which is driven thereby or generally an expansion machine. Until the predefined pressure and the predefined temperature are reached, the heated and vaporised working medium is not used to drive the axial piston machine, but to rather to heat it instead, and for this purpose the vaporised working medium is routed past the cylinders of the axial piston machine through a housing thereof, in a bypass arrangement for example. As soon as the pressure and temperature required for starting are reached, the vaporised working medium is introduced into the open cylinder of the axial piston machine, although in unfavourable conditions this is also not sufficient to start the axial piston machine, because a certain breakaway friction must be overcome.

### SUMMARY

The present invention therefore addresses the problem of describing an improved or at least alternative embodiment of an axial piston machine of the species-related type which is particularly characterized by reliable starting.

This problem is solved by the subject matter of the independent claim(s). Advantageous embodiments thereof form the subject matter of the dependent claim(s).

The present invention is based on the general idea of providing a starter device in an axial piston machine that is known per se, which starter device is able to apply a pulse-like torque to the rotor in the manner of a kick that enables the rotor to “break free” and start the axial piston machine. The axial piston machine according to the invention comprises a rotor which is mounted rotatably in a housing and cylinders disposed in a ring around said rotor, with pistons arranged to be translationally movable inside the cylinders, as is known. Now according to the invention, a starter device is provided which may be coupled to the rotor and is designed such that it applies the pulse-like torque to the rotor for starting the axial piston machine, thereby overcoming the breakaway friction when starting the axial piston machine which under certain circumstances cannot be overcome solely by the pressure of the vaporised working medium present in the cylinder. With the inventive starter device, it is thus possible to reliably start an axial piston machine arranged in a heat recovery system of a motor vehicle, thereby increasing the functional reliability of such an axial piston machine.

In an advantageous further development of the solution according to the invention, the starter device comprises a sleeve having at least one interior elevation, while a shaft of the rotor has at least one roller tappet which is spring-biased radially outwardly and runs along a track inside the sleeve on which the at least one elevation is also located. The elevation typically has one steep flank and one gently rising flank opposite thereto, wherein the direction of rotation of the sleeve relative to the shaft is aligned so that the steep flank of the elevation abuts the roller tappet and thus applies the angular momentum possibly required for starting the axial piston machine to the shaft and therewith also the rotor of the axial piston machine. In this context, the at least one elevation, which may be embodied as a kind of cam lobe for example, may have the form of an integral part of the sleeve, so that the entire sleeve including the interior elevation may be constructed as a single part, for example, in particular also together with an output shaft of the axial piston machine. In particular, it is conceivable here that the sleeve is produced in a corresponding forming process, wherein of course it is also conceivable that the sleeve is initially manufactured with a cylindrical interior circumference, and the at least one elevation is then created therein with a corresponding turning or milling tool. Because the roller tappet is spring biased radially outwardly, it is guaranteed to bear on the interior track of the sleeve and circulate thereon at all times, wherein a spring bias may be assured with a simple helical spring element, for example.

The starter device may also be equipped with a sleeve having two opposing interior elevations, and the shaft of the rotor has at least two radially outwardly spring-biased roller tappets which run along the interior track inside the sleeve on which the protrusions are also arranged.

In an advantageous refinement of the inventive solution, a freewheel device is provided which connects the rotor to the output shaft in driving manner or separates it therefrom. Such a freewheel device is necessary because the output shaft is required to exert an angular momentum to the shaft via the starter device and therewith also the rotor of the axial piston machine only initially, the rotor must not be driven or entrained afterwards, however. Accordingly, during the starting operation of the axial piston machine the freewheel device is first opened so that the angular momentum (pulse-like torque) originating from the internal combustion engine and transmitted via the output shaft may initially be applied to the shaft via the starter device. After the start axial piston machine has started and the rotor is rotating at speed, the freewheel device is closed, thereby synchronising the rotating speed of the rotor with the speed of the output shaft, and a torque input from the axial piston machine may be applied to a drivetrain of a motor vehicle for example via the output shaft. In such case, a force-transmitting connection between the output shaft of the axial piston machine and the drivetrain of the motor vehicle may be assured by a corresponding transmission, which may again be provided by a freewheel device for example, wherein the freewheel device is designed particularly to prevent a braking action on the drive train by the axial piston machine rotating more slowly.

Expediently, the at least one elevation has a height h between 2.0 mm and 5.0 mm, preferably 3.7 mm. Such an elevation enables the pulse-like torque of 1-2 Nm needed to start the inventive axial piston machine to be applied, thereby guaranteeing that the axial piston machine can be started reliably.

The present invention is further based on the general idea of equipping a motor vehicle including an internal combustion engine which is coupled to the drivetrain via a transmission with a heat recovery system in which an axial piston machine as described previously is integrated. In addition, the heat recovery system has a vaporiser which is heatable by the exhaust gas from the internal combustion engine, a pump for circulating a working medium, a condenser and said axial piston machine. Such a vehicle is able to operate significantly more economically than conventional motor vehicles, since the efficiency of the internal combustion engine can be increased significantly by utilising the waste heat of the exhaust gases. Use of the inventive axial piston machine may further ensure that it can be started reliably even when a breakaway friction exists which cannot be overcome by the vapour pressure of the working medium alone. In this context, the internal combustion engine may also be embodied as a diesel engine, for example.

The present invention is also based on the general idea of describing a method for starting an axial piston machine according to one of the preceding paragraphs in a motor vehicle in which the internal combustion engine is started first. Then, the exhaust gas discharged by the internal combustion engine is fed into a vaporiser of the heat recovery system where it heats and vaporises a working medium. However, before the working medium has reached a predefined pressure and/or a predefined temperature, it is forwarded to the axial piston machine by a pump, but it is not introduced into the cylinders there but passes around them in a bypass for example and is only used to heat the axial piston machine. When the working medium has reached its predefined temperature and/or predefined pressure, it is introduced into the open cylinder of the axial piston machine, thus enabling the axial piston machine to start. However, if an existing breakaway friction could not be overcome by the introduction of the vaporised working medium into the associated cylinder, the axial piston machine would not start. For this reason, the internal combustion engine then exerts an angular momentum on the starter device via its output shaft, and through this a pulse-like torque on the rotor, thus reliably overcoming any breakaway friction present so that the axial piston machine can be started reliably. When the rotor of the axial piston machine reaches a predefined rotating speed, the freewheel device is then closed so that the axial piston machine is connected in driving and force-transmitting manner to the drivetrain. Reliable starting of the axial piston machine can be guaranteed with the inventive method in any case.

Further important features and advantages of the invention are disclosed in the dependent claims, the drawings and the associated description of the figures in conjunction with the drawings.

Of course, the features described in the preceding text and the features which will be explained in the following text are usable not only in the specific combinations described but also in other combinations or individually, without departing from the scope of the present invention.

Preferred embodiments of the invention are illustrated in the drawings and are explained in greater detail in the following description, wherein the same reference numerals serve to identify the same or similar or functionally equivalent components.

### BRIEF DESCRIPTION OF THE DRAWINGS

In the drawing, of which the figures are all diagrammatical:

FIG. 1 shows a longitudinal section through an axial piston machine according to the invention,

FIG. 2 shows a cross section through the axial piston machine along sectional plane A-A,

FIG. 3 shows a motor vehicle with an internal combustion engine and a heat recovery system, in which an axial piston machine as represented in FIG. 1 is integrated,

FIG. 4 is a view as in FIG. 2, but with two opposing internal elevations and two radially outwardly spring biased roller tappets.

### DETAILED DESCRIPTION

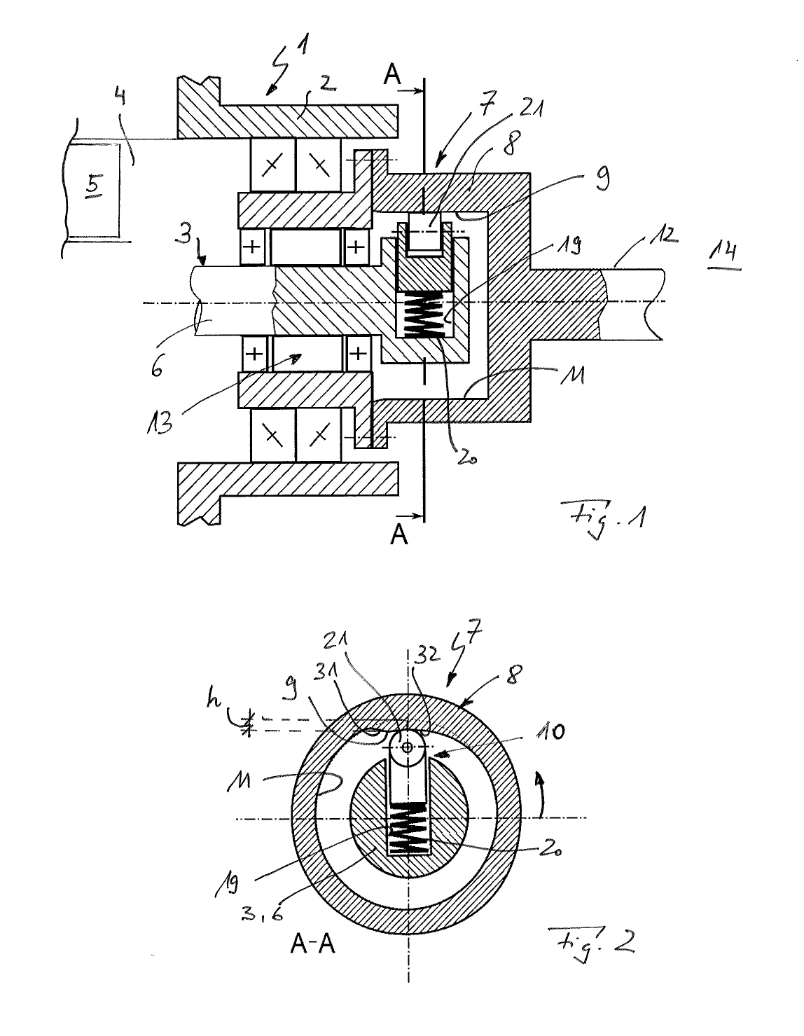

As shown in FIG. 1, an axial piston machine 1 according to the invention includes a rotor 3 mounted rotatably in a housing 2. Cylinders 4 in which pistons 5 are translationally movable are arranged in a ring around rotor 3. Not shown are, for example, a cylinder head and a swash plate, via which the individual pistons 5 are coupled with rotor 3 and a shaft 6 of rotor 3 in torque-transmitting manner. According to the invention, a starter device 7 is provided which may be coupled to rotor 3 and to shaft 6 and which is designed such that it exerts a pulse-like torque on rotor 3 for starting axial piston machine 1.

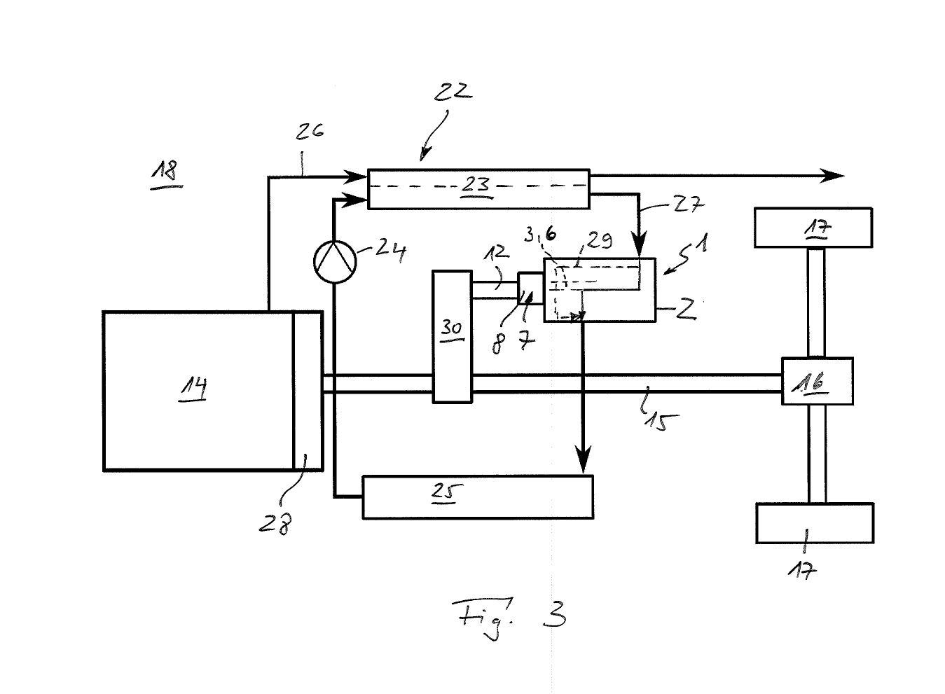

Starter device 7 is furnished with a sleeve 8 (see also FIG. 2) having at least one inner elevation 9, for example a raised cam (see also FIG. 2). Starter device 7 also may also include a sleeve 8 with two opposing inner elevations 9 (see FIG. 4). Shaft 6 of rotor 3 in turn has a radially outwardly spring-biased roller tappet 10 which runs along an inner track 11 inside sleeve 8, wherein elevation 9 is also arranged on this inner track 11 (see FIG. 2), wherein alternatively it may also be provided here that shaft 6 of rotor 3 has two or more radially outwardly spring-biased roller tappets 10. If FIG. 4 is viewed in this context, it is evident that the two roller tappets 10 are guided into one another. Sleeve 8 is connected in torque-transmitting manner to an output shaft 12 of axial piston machine 1. Sleeve 8 may also form an form an integral part of said output shaft 12.

The at least one elevation 9 has a radial height h between 2 mm and 5 mm, for example, preferably approximately 3.7 mm. In this case, the at least one elevation 9 has one steep flank 31 and one gently sloping flank 32 (see FIG. 2), and sleeve 8 rotates relative to shaft 6 of rotor 3 in such a manner so that the roller 21 of roller tappet 10 first runs onto elevation 9 up the steep flank 31 and runs off elevation 9 down the gently sloping flank 32, so that elevation 9 is also actually able to exert a pulse-like torque on rotor 3.

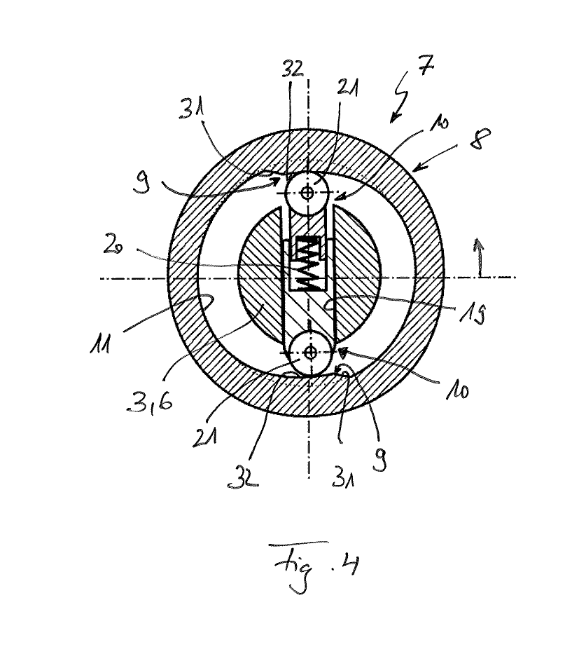

A free-wheel device 13 is also provided, connecting rotor 3 and shaft 6 to the output shaft 12 in driving manner or disconnecting them therefrom. In particular, freewheel device 13 may serve to prevent an internal combustion engine 14 (see FIG. 3) from driving not only wheels 17 of a motor vehicle 18 via a drivetrain 15 and a differential 16, but also axial piston machine 1.

The one or more roller tappet(s) 10 is/are themselves arranged in a groove 19 of shaft 6, and biased with the respective roller 21 against inner track 11 by means of a spring element 20, for example a low-cost helical spring. Theoretically, of course the roller tappet 10 may also be embodied as a sliding tappet or with a ball in this case. FIG. 4 shows that it is even possible to bias both roller tappets 10 against the inner track 11 with a single spring element 20.

Now regarding motor vehicle 18 according to FIG. 3, besides the internal combustion engine 14 the vehicle includes a heat recovery system 22 with a vaporiser 23 which is heatable by the exhaust gas from the internal combustion engine 14, a pump 24 and a condenser 25. Vaporiser 23 is embodied as a heat exchanger which transfers thermal energy from the exhaust gas 26 to a working medium 27. The heated and vaporised working medium 27 may be sued not only to heat but also to drive axial piston machine 1. Internal combustion engine 14 may be in the form of a diesel engine, for example. Additionally, a transmission 28 is typically disposed between internal combustion engine 14 and drivetrain 15.

The axial piston machine 1 according to the invention in motor vehicle 18 is started as follows:

First, internal combustion engine 14 of motor vehicle 18 is started, and the exhaust gas 26 discharged thereby is passed into vaporiser 23 where it used to warm or heat the working medium 27 of heat recovery system 22. The working medium 27 which is vaporised in vaporiser 23 is initially routed past housing 2 of the axial piston machine 1 via a bypass 29, heating the housing. When working medium 27 has reached a predefined temperature and/or a predefined pressure, it is introduced into the open cylinder 4 of axial piston machine 1 in order to start it. In this state, freewheel device 13 still idling. Since the vapour pressure introduced may not be sufficient to reliably start the axial piston machine 1 in the presence of a correspondingly strong breakaway friction, in the inventive method, the internal combustion engine 14 now exerts a pulse-like torque on rotor 3 and shaft 6 thereof via the drive train 15, the output shaft 12 of the axial piston machine 1 and the starter unit 7, whereby the breakaway friction may be reliably overcome and the axial piston machine 1 can be reliably started.

When rotor 3 reaches a predefined speed, freewheel device 13 is then closed, so that axial piston machine 1 is connected in driving manner to drive train 15 of motor vehicle 18. When freewheel device 13 is closed, the rotating speeds of drivetrain 15 on the one hand and output shaft 12 on the other are synchronised simultaneously. In theory, output shaft 12 of axial piston machine 1 may be coupled with drivetrain 15 via a corresponding transmission 30, and said transmission 30 may also be equipped with a freewheel device, not further described here.

With the axial piston machine 1 according to the invention, it is thus reliably possible to start axial piston machine 1 unfailingly, even in the presence of a not inconsiderable breakaway friction, so that a motor vehicle 18 equipped therewith may be operated as efficiently as possible.

1. An axial piston machine comprising:
a rotor mounted rotatably in a housing;
a plurality of cylinders in which a plurality of pistons are disposed such that the plurality of pistons are translationally movable, the plurality of cylinders arranged in a ring-like manner around the rotor; and
a starter device configured to exert a pulse-like torque on the rotor to initiate a starting operation, wherein the starter device is couplable to the rotor.

2. The axial piston machine according to claim 1, wherein:
the starter device includes a sleeve, the sleeve including at least one internal elevation; and
a shaft of the rotor includes at least one radially outwardly spring-biased roller tappet extending along an inner track disposed within the sleeve on which the at least one internal elevation is arranged.

3. The axial piston machine according to claim 2, wherein:
the sleeve includes two opposing internal elevations; and
the shaft of the rotor includes at least two radially outwardly spring-biased roller tappets extending along the inner track on which the two opposing elevations are arranged.

4. The axial piston machine according to claim 2, wherein the at least one elevation includes a steep flank and a gently sloping opposite flank.

5. The axial piston machine according to claim 2, further comprising an output shaft, wherein the sleeve is integrally arranged on the output shaft.

6. The axial piston machine according to claim 5, further comprising a freewheel device configured to at least one of 1) connect the rotor with the output shaft in a driving manner and 2) disconnect the rotor from the output shaft.

7. The axial piston machine according to claim 2, wherein the at least one elevation has a height from 2.0 mm to 5.0 mm, particularly h approximately 3.7 mm.

8. The axial piston machine according to claim 1, wherein the starter device configured to provide a pulse-like torque from 1 to 2 Nm.

9. A motor vehicle comprising:
an internal combustion engine coupled to a drivetrain via a transmission;
a heat recovery system including a vaporiser; and
an axial piston machine including a rotor rotatably mounted within a housing, a plurality of cylinders arranged in a ring-like manner around the rotor, and a starter device couplable to the rotor, the plurality of cylinders including a plurality of translationally movable pistons disposed therein, the starter device configured to exert a pulse-like torque on the rotor to initiate a starting operation;
wherein the vaporiser is heatable by exhaust gas of the internal combustion engine, a pump, a condenser, and the axial piston machine.

10. The motor vehicle according to claim 9, wherein the internal combustion engine is a diesel engine.

11. A method for starting an axial piston machine in a motor vehicle comprising:
starting an internal combustion engine coupled to a drivetrain via a transmission;
heating and vaporising a working medium disposed within a vaporiser of a heat recovery system via exhaust gas discharged from the internal combustion engine;
heating a housing of an axial piston machine via directing the working medium vaporised in the vaporiser through the housing of the axial piston machine via a bypass;
feeding the working medium vaporized into an opened cylinder of the axial piston machine after the vaporised working medium reaches at least one of a predefined temperature and a predefined pressure, wherein the opened cylinder is one of a plurality of cylinders arranged in a ring-like matter around a rotor rotatably mounted within the housing, the plurality of cylinders including a plurality of translationally movable pistons disposed therein;
starting the axial piston machine via exerting a pulse-like torque on the rotor via an output shaft of the axial piston machine and a starter device coupled to the rotor; and
closing a freewheel device of the axial piston machine and connecting the axial piston machine to the drivetrain in a driving manner after the rotor reaches a predefined rotating speed.

12. The axial piston machine according to claim 7, wherein the at least one elevation has a height of approximately 3.7 mm.

13. The axial piston machine according to claim 3, wherein at least one of the two opposing internal elevations includes a steep flank and a gently sloping opposite flank.

14. The axial piston machine according to claim 13, further comprising an output shaft, wherein the sleeve is integrally arranged on the output shaft.

15. The axial piston machine according to claim 14, further comprising a freewheel device configured to at least one of 1) connect the rotor with the output shaft in a driving manner and 2) disconnect the rotor from the output shaft.

16. The axial piston machine according to claim 15, wherein the two opposing internal elevations has a height from 2.0 mm to 5.0 mm.

17. The motor vehicle according to claim 9, wherein:
the starter device includes a sleeve, the sleeve including at least one internal elevation; and
a shaft of the rotor includes at least one radially outwardly spring-biased roller tappet extending along an inner track disposed within the sleeve on which the at least one elevation is arranged.

18. The motor vehicle according to claim 17, wherein the at least one internal elevation includes a steep flank and a gently sloping opposite flank.

19. The motor vehicle according to claim 18, further comprising an output shaft, wherein the sleeve is integrally arranged on the output shaft.

20. The motor vehicle according to claim 19, further comprising a freewheel device configured to at least one of 1) connect the rotor with the output shaft in a driving manner and 2) disconnect the rotor from the output shaft.
